(19) United States
(12) Patent Application Publication
(10) Pub. No.: US 2015/0109586 A1
(43) Pub. Date: Apr. 23, 2015

(54) SCANNING PROJECTION APPARATUS AND PORTABLE PROJECTION APPARATUS

(71) Applicant: Makoto MASUDA, Nara-shi (JP)

(72) Inventor: Makoto MASUDA, Nara-shi (JP)

(21) Appl. No.: 14/516,823

(22) Filed: Oct. 17, 2014

(30) Foreign Application Priority Data
Oct. 18, 2013 (JP) 2013-217043

(51) Int. Cl. H04N 9/31; G02B 26/08; G02B 26/10

(52) U.S. Cl. CPC H04N 9/3129; G02B 26/105; G02B 26/0841
USPC 353/31; 359/214.1; 359/204.4; 359/199.2; 353/98

(57) ABSTRACT

A scanning projection apparatus is provided with a first light source module which includes a laser light source to emit a laser beam and a mirror unit which can be oscillated. Further, a light deflection unit which performs a two-dimensional scanning with the laser beam emitted from the first light source module by the mirror unit, a light detection unit which detects a distance from the mirror unit to an image projection surface or a difference in distance in the image projection surface, and a control unit which controls an oscillation angle of the mirror unit based on distance information from the light detection unit are included.

### CROSS REFERENCE TO RELATED APPLICATION

This application is based upon and claims the benefit of priority from Japanese patent application No. 2013-217043, filed on Oct. 18, 2013, the disclosure of which is incorporated herein in its entirety by reference.

### TECHNICAL FIELD

The present invention relates to a scanning projection apparatus and a portable projection apparatus which employs the scanning projection apparatus.

### BACKGROUND ART

There is known a scanning projection apparatus which makes laser beams of three primary colors (red, green, and blue) converged into one laser beam and performs a two-dimensional scanning onto an image projection surface to form a projection image. In such a scanning projection apparatus, in a case where a distance from a laser light source to the image projection surface is not constant, illuminance of a portion of the image projection surface is reduced compared to the other portions as the distance is increased. JP 2010-107738 A discloses a scanning projection apparatus which changes illuminance according to a difference in distance in the image projection surface so that a partial reduction in illuminance is prevented. Further, JP 2011-107347 A discloses a scanning projection apparatus which is configured to switch the arrangement of the image projection surface according to a position of the viewer. Further, JP 2000-152202 A discloses a light source, an image forming unit such as an LCD, and a projection apparatus which projects an image formed by the image forming unit onto the image projection surface.

### SUMMARY OF INVENTION

### Technical Problem

The scanning projection apparatuses disclosed in JP 2010-107738 A and JP 2011-107347 A can handle a case where the image projection surface is substantially the even surface. In a case where the image projection surface is not the even surface, for example, a case where the image projection surface includes an uneven structure or a case where the image projection surface has a curved surface, it is difficult to make brightness of the projection image uniform. Further, in JP 2000-152202 A, since a screen size becomes large as the distance from the light source to the image projection surface is increased, the brightness is not sufficiently obtained. Therefore, there is a problem in that the distance from the light source to the image projection surface is restricted.

The invention has been made in view of the above circumstances, and an object thereof is to provide a scanning projection apparatus which can project a projection image or a midair image having a small difference in illuminance even in a case where the image projection surface has a three-dimensional uneven structure or the image projection surface formed of a curved surface causing a distance from the light source to be different. Further, another object of the invention is to provide a portable projection apparatus which employs the scanning projection apparatus.

### Solution to Problem

In order to solve the above-mentioned problems, the invention provides a scanning projection apparatus including a light source module which includes a laser light source to emit a laser beam, a light deflection unit which includes an oscillating mirror unit and performs a two-dimensional scanning with the laser beam emitted from the light source module by the mirror unit to project a projection image onto an image projection surface, And the scanning projection apparatus includes a light detection unit which detects a distance from the mirror unit to the image projection surface or a difference in distance in the image projection surface, and a control unit which controls an oscillation angle of the mirror unit based on distance information from the light detection unit.

Further, in addition to the above invention, the light source module may include any one or all of a red laser light source, a green laser light source, and a blue laser light source.

Further, in addition to the above invention, the laser light source may include a plurality of laser light sources which emit laser beams different in wavelength according to an image signal. The scanning projection apparatus further includes a multiplexing unit which synthesizes the laser beams emitted from the plurality of laser light sources.

Further, in addition to the above invention, the light deflection unit may have a MEMS structure of an electrostatic drive system in which the mirror unit and a mirror driving unit to oscillate the mirror unit are included.

Further, in addition to the above invention, the mirror unit may be separately oscillated by two shafts perpendicular to each other, and oscillation angles of the two shafts may be separately controlled based on the distance information by the control unit.

Further, in addition to the above invention, the light deflection unit may include an oscillation angle detection unit which detects the oscillation angle of the mirror unit.

Further, in addition to the above invention, the scanning projection apparatus further includes a combining light source module which emits the laser beam and is combined with the light source module. The laser beam emitted from the light source module and the laser beam emitted from the combining light source module may be synthesized by the multiplexing unit.

Further, another aspect of the invention provides a scanning projection apparatus according to the invention includes a light source module which includes a laser light source to emit a laser beam, a light deflection unit which includes an oscillating mirror unit and performs a two-dimensional scanning with the laser beam emitted from the light source module by the mirror unit to project a projection image onto an image projection surface, an irradiation light projection unit which reflects the laser beam emitted from the light deflection unit in a direction different from an emitting direction, and a transparent optical imaging unit which is disposed at a predetermined angle with respect to a projection surface of the irradiation light projection unit in the emitting direction of a reflection light beam from the irradiation light projection unit. The projection image is projected into a space on a side opposite to the irradiation light projection unit with the optical imaging unit interposed therebetween.

Further, in addition to the above invention, the scanning projection apparatus may be configured such that an angle of the optical imaging unit with respect to the irradiation light projection unit is changed according to a position on a visual line of a viewer.

Further, a portable projection apparatus according to the invention includes the scanning projection apparatus described above.

### BRIEF DESCRIPTION OF DRAWINGS

FIG. 1 is a diagram schematically illustrating a scanning projection apparatus according to a first embodiment of the invention;

FIG. 2 is a diagram illustrating a schematic configuration of a first light source module according to the first embodiment of the invention;

FIG. 3 is a diagram illustrating a schematic configuration of the first light source module according to a modified example of FIG. 2;

FIG. 4 is a diagram illustrating an example of a schematic configuration of a second light source module according to the first embodiment of the invention;

FIG. 5 is a plan view illustrating an example of a configuration of a light deflection unit according to the first embodiment of the invention;

FIG. 6 is a diagram illustrating a scan image in a case of a raster scan;

FIG. 7 is a diagram illustrating a scan image in a case of a Lissajous scan;

FIG. 8 is a block diagram illustrating a main configuration of a control unit according to the first embodiment of the invention;

FIG. 9 is a diagram illustrating an example in a case where an image projection surface according to the first embodiment of the invention has a three-dimensional uneven structure;

FIG. 10 is a diagram illustrating an example in a case where the image projection surface according to the first embodiment of the invention is a curved structure;

FIG. 11 is a diagram schematically illustrating a scanning projection apparatus according to a second embodiment of the invention;

FIG. 12A is a perspective view illustrating an example of a configuration of an optical imaging unit according to the second embodiment of the invention;

FIG. 12B is a plan view illustrating a part of the optical imaging unit of FIG. 12A; and

FIG. 13 is a schematic view illustrating a use state of a portable projection apparatus according to a third embodiment of the invention.

### DESCRIPTION OF EMBODIMENTS

Hereinafter, a scanning projection apparatus and a portable projection apparatus according to embodiments of the invention will be described with reference to the drawings.

### First Embodiment

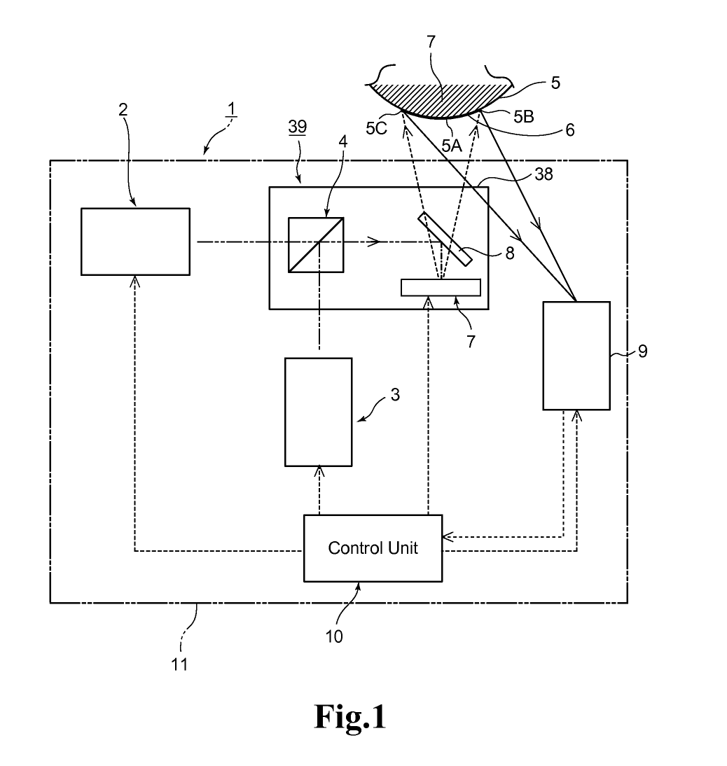

FIG. 1 is a diagram schematically illustrating a scanning projection apparatus 1 according to a first embodiment of the invention. As illustrated in FIG. 1, the scanning projection apparatus 1 includes two light source modules 2 and 3 which emit laser beams, a multiplexing unit 4 which synthesizes the laser beams emitted from these light source modules 2 and 3 into one laser beam, and a light deflection unit 7 which performs a two-dimensional scanning with the laser beam according to an image signal to project a projection image 6 onto an image projection surface 5. In the embodiment, an optical element 8 is provided between the light deflection unit 7 and the image projection surface 5. Further, the scanning projection apparatus 1 is provided with a light detection unit 9 which detects a reflection light beam from the image projection surface 5. In addition, the light source modules 2 and 3 will be denoted by a first light source module 2 and a second light source module 3 in order to make a distinction therebetween.

When the first light source module 2 is used as a main light source module, the second light source module 3 serves as a combining light source module which may be used in combination with the first light source module 2 according to applications. Therefore, the second light source module 3 is not necessarily provided in some cases. Further, the scanning projection apparatus 1 may be added with a third light source module.

For example, in a case where the image projection surface 5 is a curved surface as illustrated in FIG. 1, the light detection unit 9 detects distances between a light deflection unit 7 and each of a center position 5A within the nearest distance from the light deflection unit 7, a right end position 5B and a left end position 5C located in a remote place from the center position 5A, or detects a difference between the distances at the respective positions. As the light detection unit 9, for example, there can be used an image capture unit such as a CCD camera and a CMOS camera, a photo sensor, or a photo diode of a light projection/reception system.

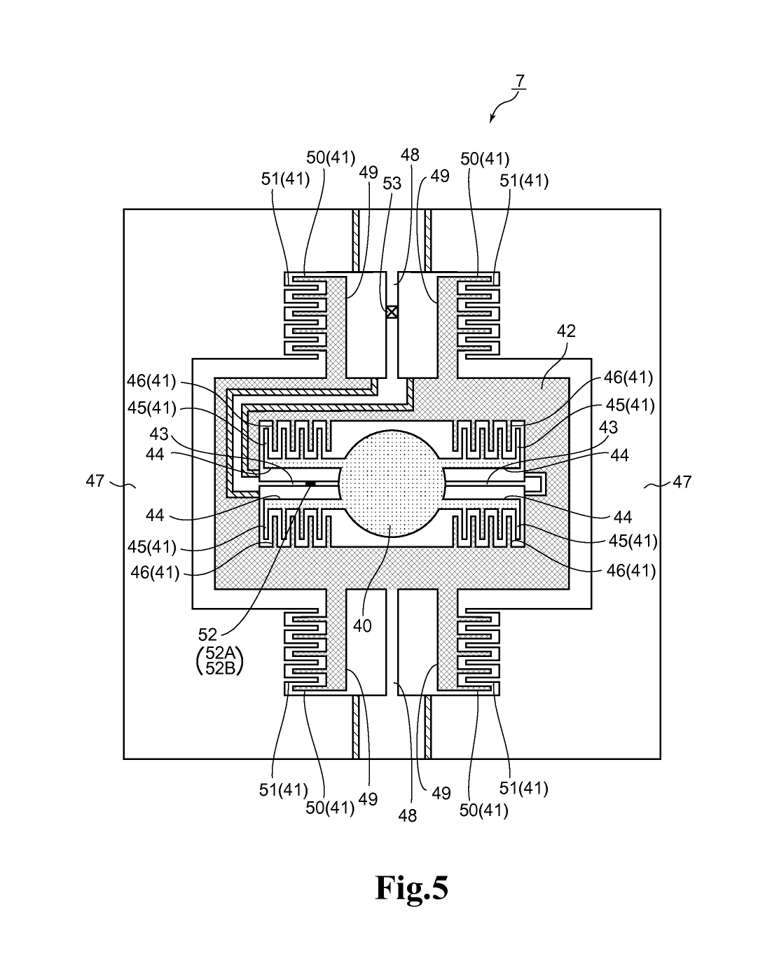

Besides the above-mentioned optical elements, the scanning projection apparatus 1 of the embodiment includes a control unit 10 as illustrated in FIG. 1. The control unit 10 serves to drive the first light source module 2, the second light source module 3, the light deflection unit 7, and the light detection unit 9 and controls a detection operation. The respective elements described above are contained in a housing 11. A light-emitting aperture (not illustrated) for the scanning laser beam is provided in a side surface facing the image projection surface 5 of the housing 11. The light deflection unit 7 includes a mirror unit 40 and a mirror driving unit 41 which oscillates the mirror unit 40, and the detailed configuration thereof will be described below with reference to FIG. 5.

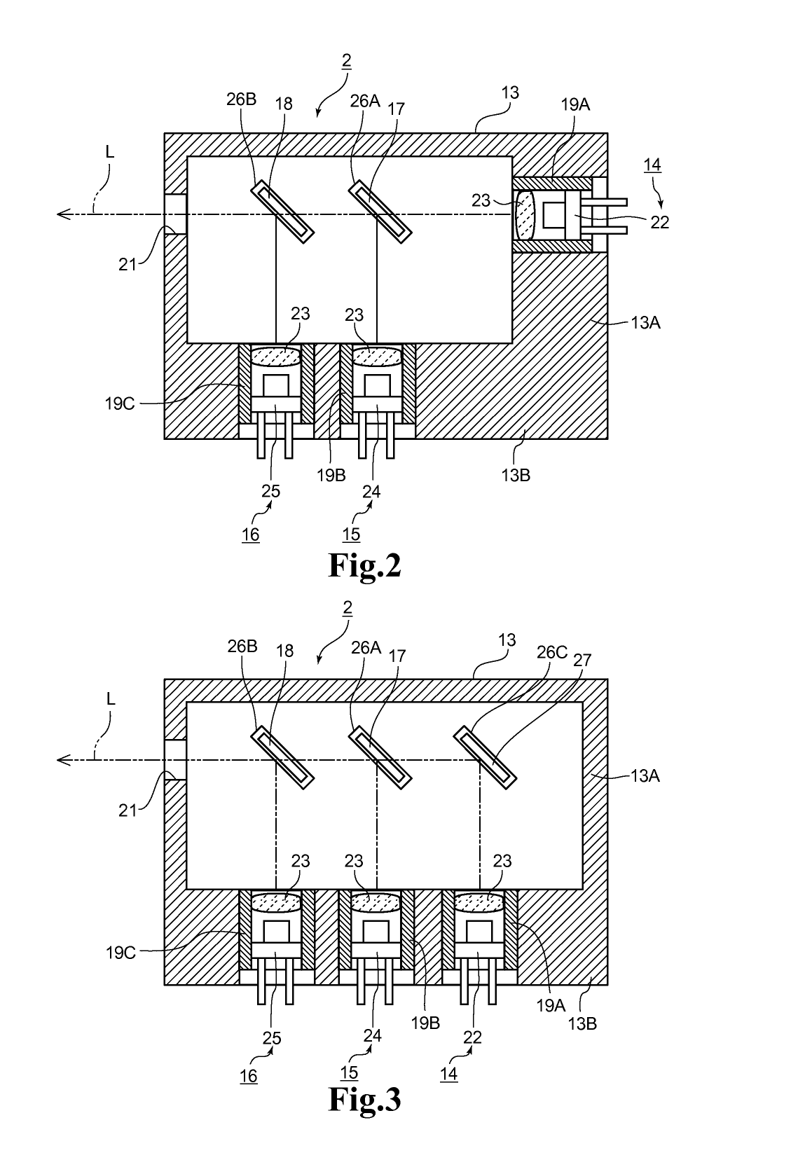

Next, the configuration of the first light source module 2 will be described. FIG. 2 is a diagram illustrating a schematic configuration of the first light source module 2 and corresponds to a cross-sectional, plan view. As illustrated in FIG. 2, the first light source module 2 includes a housing 13, three laser light sources 14, 15, and 16, and dichroic mirrors 17 and 18. The housing 13 includes light source attachment portions 19A, 19B, and 19C. The laser light sources 14, 15, and 16 which can emit laser beams having wavelengths of red, green, and blue are attached to the light source attachment portions 19A, 19B, and 19C, respectively.

In the configuration illustrated in FIG. 2, the light source attachment portion 19A is provided in a wall portion 13A of the housing 13 intersecting with the extension of an optical axis L toward a circular light-emitting aperture 21 provided in the housing 13. A red laser light source 22 which can emit a red laser beam and a collimator lens 23 are attached to the light source attachment portion 19A.

Further, the light source attachment portions 19B and 19C are provided in a wall portion 13B intersecting with the wall portion 13A. Among them, the laser light source 15 is provided at a position near the light source attachment portion 19A, and a green laser light source 24 which can emit a green laser beam and another collimator lens 23 are attached thereto. Further, the light source attachment portion 19C is disposed at a position away from the light source attachment portion 19A further than the light source attachment portion 19B, and a blue laser light source 25 which can emit a blue laser beam and another collimator lens 23 are attached thereto. Each collimator lens 23 adjusts the laser beams emitted from the laser light source of the corresponding color to be a parallel light beam and emits the beam.

In addition, the red laser beam is a laser beam having a single wavelength in a range of 635 nm to 690 nm, and for example a laser beam having a wavelength of 640 nm is employed in the embodiment. Further, the green laser beam is a laser beam having a single wavelength in a range of 500 nm to 560 nm, and for example a laser beam having a wavelength of 515 nm is employed in the embodiment. Further, the blue laser beam is a laser beam having a single wavelength in a range of 435 nm to 480 nm, and for example a laser beam having a wavelength of 450 nm is employed in the embodiment. The laser light sources of these colors can be realized using laser diodes corresponding to the wavelengths of red, green, and blue.

Further, mirror attachment portions 26A and 26B are provided in the housing 13, and the dichroic mirrors 17 and 18 are attached to the mirror attachment portions 26A and 26B, respectively. In the embodiment, the dichroic mirror 17 which reflects the green laser beam but transmits the red laser beam and the like is attached on the optical axis of the green laser light source 24. In addition, the dichroic mirror 17 may be configured to transmit only the red laser beam. Further, the dichroic mirror 18 which transmits a laser beam having a wavelength of green and longer than that of green but reflects the blue laser beam having a wavelength shorter than that of green is attached on the optical axis of the blue laser light source 25. In addition, the dichroic mirror 18 may be configured to reflect only the blue laser beam and transmit the other laser beams, or may be configured to transmit only the red and green laser beams and reflect the other laser beam.

In addition, the configuration as illustrated in FIG. 3 may be employed instead of the configuration as illustrated in FIG. 2. FIG. 3 is a diagram illustrating a schematic configuration of the first light source module 2 according to a modified example of FIG. 2 and corresponds to a cross-sectional, plan view. In addition, the optical elements in the same relation as those in FIG. 2 are denoted by the same reference numerals, and the descriptions thereof will not be repeated.

For example, in a case where a region for providing an electrical connection of the first light source module 2 is restricted due to a spatial constraint of the scanning projection apparatus 1, the construction illustrated in FIG. 3 can be used. In the configuration illustrated in FIG. 3, the light source attachment portions 19A, 19B, and 19C are provided in the same wall portion 13B. Further, a new mirror attachment portion 26C is provided in order to reflect the red laser beam emitted from the red laser light source 22 attached to the light source attachment portion 19A. A dichroic mirror 27 to reflect the red laser beam is attached to the mirror attachment portion 26C.

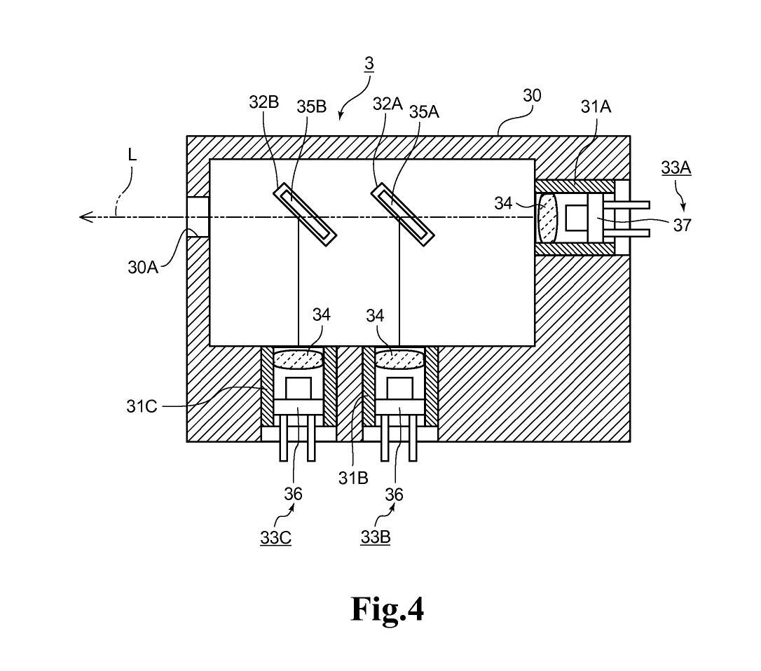

Next, the second light source module 3 corresponding to the combining light source module will be described. FIG. 4 is a diagram illustrating an example of a schematic configuration of the second light source module 3 and corresponds to a cross-sectional, plan view. In addition, basically, many parts of the second light source module 3 are configured in common with the first light source module 2 illustrated in FIG. 2. In other words, a housing 30 in the second light source module 3 is configured in common with the housing 13 illustrated in FIG. 2. Further, the housing 30 includes light source attachment portions 31A, 31B, and 31C equal to the light source attachment portions 19A, 19B, and 19C provided in the housing 13, mirror attachment portions 32A and 32B equal to the mirror attachment portions 26A and 26B, and a light-emitting aperture 30A equal to the light-emitting aperture 21.

However, laser light sources 33A, 33B, and 33C attached to the light source attachment portions 31A, 31B, and 31C of the housing 30 may be appropriately changed according to the applications of the scanning projection apparatus 1. In other words, a laser light source which can emit an appropriate laser beam according to necessary chromaticity or brightness can be configured to be attached to any one of the light source attachment portions 31A, 31B, and 31C.

In addition, as the laser light sources 33A, 33B, and 33C and three collimator lenses 34 illustrated in FIG. 4, those equal to the laser light sources 14, 15, and 16 and the respective collimator lenses 23 illustrated in FIG. 2 may be used or other types may be used as needed. Further, as dichroic mirrors 35A and 35B attached to the mirror attachment portions 32A and 32B, those equal to the dichroic mirrors 17 and 18 illustrated in FIG. 2 may be used or other types may be used as needed.

The following configuration may be given as an example of the laser light sources 33A, 33B, and 33C attached to the light source attachment portions 31A, 31B, and 31C. For example, in a case where an image is formed by synthesizing the laser beams, it is necessary to form the white light. The white light is formed by synthesizing the red, green, and blue laser beams at a predetermined ratio. However, though the amount of the blue laser beam is large, it does not contribute greatly to the improvement in brightness (illuminance).

As illustrated in FIG. 1, the laser beams emitted from the first light source module 2 and the second light source module 3 are multiplexed (synthesized) into one optical flux by the multiplexing unit 4. Therefore, the laser beam after being emitted from the multiplexing unit 4 gains in brightness compared to that emitted only from the first light source module 2. Accordingly, in a case where the second light source module 3 includes, for example, a green laser light source 36, the brightness can be increased compared to the case where only the first light source module 2 is used.

Therefore, in the second light source module 3, a red laser light source 37 emitting the red laser beam and the green laser light source 36 emitting the green laser beam may be provided without providing the blue laser light source emitting the blue laser beam. For example, in a case where three laser light sources are disposed, all of them may be provided as the red laser light source 37, all of them may be provided as the green laser light source 36, or one or two red laser light sources 37 may be provided and the rest may be provided as the green laser light source 36.

In particular, the green laser light source 36 greatly contributes to the improvement in brightness. Therefore, on the contrary, in a case where the efficiency of the red laser light source 22 is made to be high in the first light source module 2, the white light can be formed in the second light source module 3 even by employing a configuration in which only the green laser light sources 36 are provided, or a configuration in which the green laser light sources 36 are provided more than the number of the red laser light sources 37.

In the configuration illustrated in FIG. 4, two green laser light sources 36 and one red laser light source 37 are provided in order to increase the brightness.

In addition, there can be employed, if necessary, various types of laser light sources emitting laser beams such as a yellow laser beam, a blue-violet laser beam, a violet laser beam, an orange laser beam, and a laser beam in an ultraviolet region.

As described above, the second light source module 3 may be configured by combining various types of laser light sources according to a required (desired) brightness or a request for a product having another option. In other words, the second light source module 3 serves as the combining light source module with respect to the main first light source module 2.

Further, the second light source module 3 may be configured such that infrared sensors having laser light sources which can emit infrared laser beams are attached instead of the red, green, and blue laser light sources 33A, 33B, and 33C as illustrated in FIG. 4. In addition, the infrared sensor further includes a light receiving unit which receives the reflection light beam from the image projection surface 5, so that a distance to a target portion (for example, a projection surface) can be measured by the light receiving unit which receives the reflection light beam. Therefore, such an infrared sensor has a function of the light detection unit 9 illustrated in FIG. 1. Examples of such a sensor include various types of sensors such as a sensor which uses a photo diode of a light projection/reception system and a sensor which detects a position (for example, the respective positions 5A, 5B, and 5C illustrated in FIG. 1) on the image projection surface 5 through image processing. With such a configuration, the second light source module 3 can also serve as the light detection unit 9.

As the multiplexing unit 4, a prism may be used. Besides the prism as the multiplexing unit 4, the optical element 8 such as a collective lens, a collimator lens, and a mirror may be disposed as needed. Further, the mirror is used instead of the prism, and besides the mirror, the optical element 8 such as a collective lens, a collimator lens, and a mirror may be disposed as needed (only the mirror is illustrated as a representative configuration of the optical element 8 in FIG. 1).

As illustrated in FIG. 1, the laser beams each emitted from the first light source module 2 and the second light source module 3 form a parallel light beam which passes through the multiplexing unit 4 and, if necessary, passes through the optical element 8, and then is incident to the light deflection unit 7. In the configuration illustrated in FIG. 1, the multiplexing unit 4 and the light deflection unit 7 are integrally attached to a housing 38, and form one optical unit 39. However, the multiplexing unit 4 and the light deflection unit 7 may be configured to be individually adjusted in position without the attachment to the housing 38.

The light deflection unit 7 includes the mirror unit 40 as illustrated in FIG. 5. The mirror unit 40 is oscillated by the mirror driving unit 41 to be described below, so that the image projection surface 5 is scanned with the laser beam to form the projection image 6. The light deflection unit 7 of the embodiment has a micro electro mechanical systems (MEMS) structure in which an actuator of an electrostatic drive system is included, and the configuration is illustrated in FIG. 5.

FIG. 5 is a plan view illustrating an exemplary configuration of the light deflection unit 7. The light deflection unit 7 illustrated in FIG. 5 includes an inner frame 42, the mirror unit 40 is disposed almost in the center portion inside the inner frame 42, and is supported on the both ends by the inner frame 42 through the torsional shaft 43. The mirror unit 40 is formed by depositing a reflective member such as silver on a wafer, and when the mirror unit 40 is formed, an appropriate material, a deposit thickness, and a configuration of deposit layers are determined according to a wavelength, an intensity, and a reflection efficiency of the laser beam.

The torsional shaft 43 is a shaft component which allows the inner frame 42 to oscillate and twist the mirror unit 40. Further, extension portions 44 are extended from the mirror unit 40 with the torsional shaft 43 interposed therebetween, and a plurality of mirror-side comb-like electrodes 45 are provided to protrude from the extension portion 44. The mirror-side comb-like electrodes 45 are alternately inserted into first comb-like electrodes 46 of the inner frame 42. The mirror driving unit 41 is configured by the mirror-side comb-like electrodes 45 and the first comb-like electrodes 46. Any one of the mirror-side comb-like electrodes 45 and the first comb-like electrodes 46 protrudes to the top surface or the bottom surface of the light deflection unit 7 compared to the other electrodes. Therefore, when a voltage is applied to the mirror-side comb-like electrode 45 and the first comb-like electrode 46, an electric field is generated, and a torsional force is applied to the torsional shaft 43 by an attractive force and a repulsive force working therebetween, so that the mirror unit 40 can be oscillated (driven) about the torsional shaft 43 as a rotation shaft.

Further, the inner frame 42 is supported to an outer frame 47 through the torsional shaft 48 which can be twisted, and the same configuration as that between the mirror unit 40 and the inner frame 42 is provided also between the inner frame 42 and the outer frame 47. In other words, extension portions 49 are extended from the inner frame 42 with the torsional shaft 48 interposed therebetween, and second comb-like electrodes 50 are provided to protrude from the extension portion 49. The second comb-like electrodes 50 are alternately inserted into outer-frame-side comb-like electrodes 51 of the outer frame 47. One mirror driving unit 41 is configured by the second comb-like electrodes 50 and the outer-frame-side comb-like electrodes 51. Then, any one side of the second comb-like electrodes 50 and the outer-frame-side comb-like electrodes 51 protrudes from the top surface or the bottom surface of the light deflection unit 7 compared to the other electrodes. Therefore, when a voltage is applied to the second comb-like electrode 50 and the outer-frame-side comb-like electrode 51, an electric field is generated, and the torsional force is applied to the torsional shaft 48 by the attractive force and the repulsive force working therebetween, so that the mirror unit 40 can be oscillated (driven) about the torsional shaft 48 as a rotation shaft.

A period and a range of vibration of the mirror unit 40 can be set between the mirror-side comb-like electrode 45 and the first comb-like electrode 46, and between the second comb-like electrode 50 and the outer-frame-side comb-like electrode 51 according to the applied voltages. Then, in a case when a drive cycle of the mirror unit 40 is shortened, the drive cycle is desirable to be close a resonance frequency of the mirror unit 40. In the embodiment, the torsional shaft 43 relating to a main scanning is applied with a voltage of 120 V at 20 KHz, and the torsional shaft 48 relating to a sub scanning is applied with a voltage of 50 V at 60 Hz, so that the mirror unit is oscillated at twist angles of 40 degrees in a main scanning direction and of 20 degrees in a sub scanning direction. However, the configuration is not limited to these frequencies, voltages, and twist angles, but various other settings can be made. In addition, the mirror unit 40 is separately oscillated by the two shafts (the torsional shaft 43 and the torsional shaft 48) perpendicular to each other. In addition, the twist angle corresponds to an oscillation angle of the mirror unit 40.

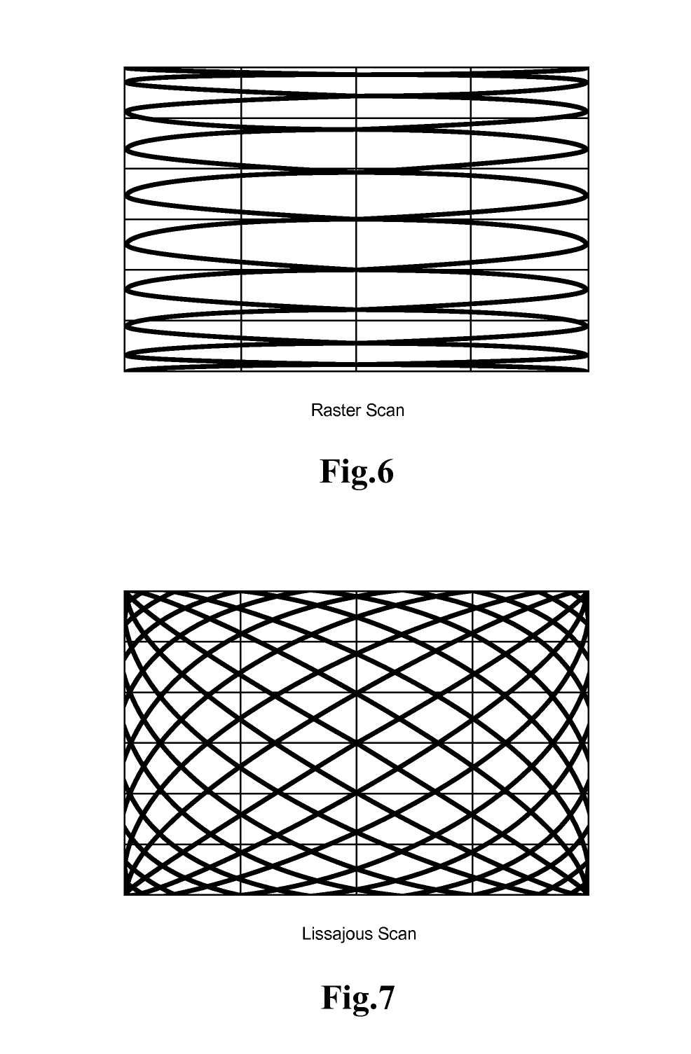

Further, the voltages applied to the respective comb-like electrodes 45, 46, 50, and 51 can be appropriately set according to a tracking property of the mirror unit 40 such as a trapezoid waveform or a sawtooth waveform besides the sine waveform. Then, the scanning is performed with the laser beam by a drive control of the mirror driving unit 41. As the scan method to form the projection image, two types of the method as illustrated in FIGS. 6 and 7 are employed in many cases. FIG. 6 is a diagram illustrating a scan image in the case of a raster scan. Further, FIG. 7 is a diagram illustrating a scan image in the case of a Lissajous scan. In addition, in the raster scan, the sub scanning direction may not be the sine waveform but the sawtooth waveform. In a control system, information for forming such a scan image (scanning locus) is expressed as drawing line information.

As illustrated in FIG. 5, the light deflection unit 7 includes oscillation angle detection units 52 and 53 which detect the oscillation angle of the mirror unit 40. The oscillation angle detection unit 52 is attached to the torsional shaft 43, and the oscillation angle detection unit 53 is attached to the torsional shaft 48, both of which have the same configuration and thus one of two will be described as a representative. The oscillation angle detection unit 52 includes a piezoelectric element 52A which is provided in the torsional shaft 43 of the light deflection unit 7 and an electromotive force detection unit 52B which detects an electromotive force generated from the piezoelectric element 52A.

The piezoelectric element 52A is deformed following the torsional shaft 43 which is torsionally deformed according to the oscillation (a rotation about the torsional shaft 43) of the mirror unit 40. After the electromotive force according to a deformed volume is generated, the piezoelectric element 52A can obtain the twist angle of the torsional shaft 43 based on a magnitude of the electromotive force detected by the electromotive force detection unit 52B. Then, the oscillation angle (a swing angle) of the mirror unit 40 can be detected from the twist angle.

In addition, the oscillation angle of the mirror unit 40 may be continuously detected, or may be intermittently detected. Further, the oscillation angle detection units 52 and 53 are not limited to the piezoelectric element, and for example an optical sensor or an electrostatic capacitive sensor may be employed as long as the oscillation angle of the mirror unit 40 can be detected.

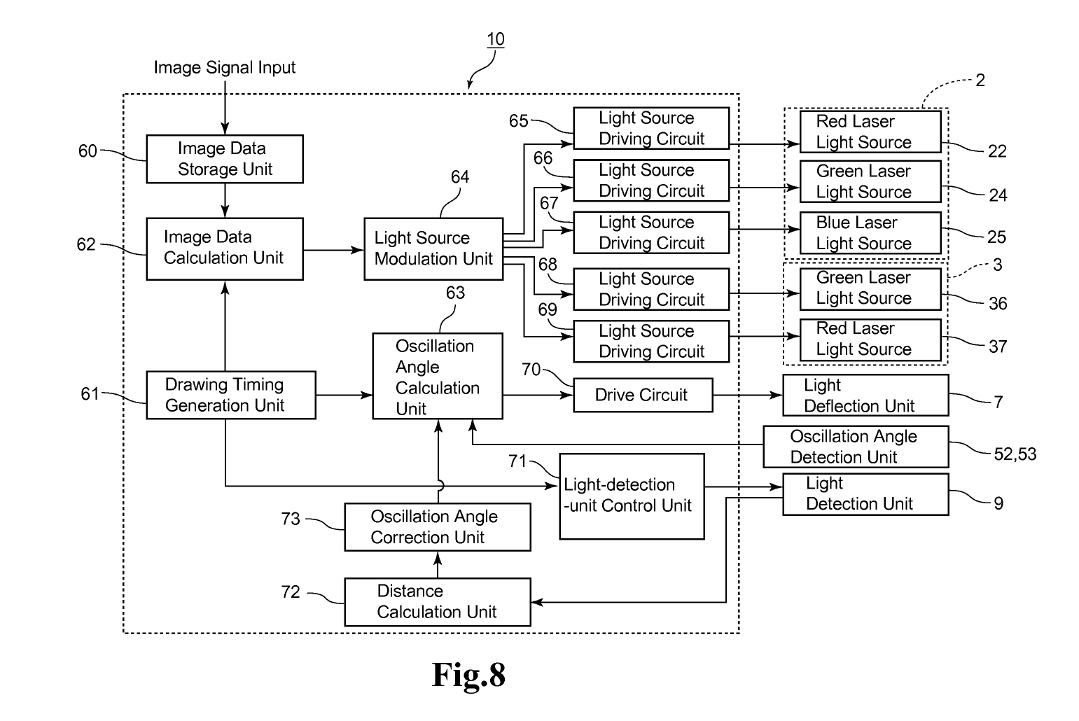

Further, as illustrated in FIG. 1, the scanning projection apparatus 1 of the embodiment includes the control unit 10 which serves to drive the first light source module 2, the second light source module 3, the light deflection unit 7, and the light detection unit 9 and controls the detection operation. Next, the configuration and operation of the control unit 10 will be described with reference to FIG. 8.

FIG. 8 is a block diagram illustrating a main configuration of the control unit 10 according to the embodiment. In addition, FIG. 8 illustrates an exemplary configuration in which the first light source module 2 described with reference to FIG. 2 and the second light source module 3 described with reference to FIG. 4 are employed. The control unit 10 first receives an image signal indicating image data, and temporarily stores the image data in an image data storage unit 60. A drawing timing generation unit 61 generates drawing timing information and drawing line information. The drawing timing information is sent out to an image data calculation unit 62, and the drawing line information is sent out to an oscillation angle calculation unit 63. The drawing timing information contains the timing information and the like to be used for drawing an image. Further, the drawing line information contains information (two-dimensional scanning position information) of the scanning locus of the laser beam used for drawing an image.

The image data calculation unit 62 calls the image data corresponding to a drawing pixel from the image data storage unit 60 based on the drawing timing information input from the drawing timing generation unit 61, performs various calculations, and sends brightness data of the respective colors out to a light source modulation unit 64. The light source modulation unit 64 adjusts the outputs of the laser light sources of the respective colors through light source driving circuits based on the brightness data corresponding to the respective colors of the first light source module 2 and the second light source module 3 input from the image data calculation unit 62. As illustrated in FIG. 8, a light source driving circuit 65 drives the red laser light source 22, and a light source driving circuit 67 drives the blue laser light source 25. A light source driving circuit 66 drives the green laser light source 24, a light source driving circuit 68 drives the green laser light source 36, and a light source driving circuit 69 drives the red laser light source 37.

The oscillation angle calculation unit 63 calculates the oscillation angle of the mirror unit 40 of the light deflection unit 7 based on the drawing line information input from the drawing timing generation unit 61, determines a voltage to be applied to the mirror driving unit 41 by a drive circuit 70, and controls the oscillation angle (the twist angles of the torsional shafts 43 and 48) of the mirror unit 40 based on the information.

A light-detection-unit control unit 71 controls the light detection unit 9 based on the drawing timing information sent from the drawing timing generation unit 61. The light detection unit 9 detects a reflection light beam from the image projection surface 5 of a projection area of the projection image 6. Then, the light detection unit 9, for example, inputs information of the positions 5A, 5B, 5C on the image projection surface 5 illustrated in FIG. 1 or information such as a difference in intensity (a difference in brightness) and a difference in time from emitting to receiving the light between the respective positions into a distance calculation unit 72. The distance calculation unit 72 obtains the positions 5A, 5B, and 5C on the image projection surface 5, distances from the mirror unit 40 to the respective detection positions, or a difference in distance between the respective detection positions based on the information input from the light detection unit 9, and transmits these pieces of distance information to an oscillation angle correction unit 73.

The projection image emitted from the light deflection unit 7 becomes wider as a distance from the light deflection unit 7 (the mirror unit 40) is increased. For example, in the projection image 6 illustrated in FIG. 1, the distance is increased as it goes to the positions 5B and 5C on the right and left outer sides compared to the position 5A. Since the distance is increased, the image is widened, so that the illuminance (brightness) at the position where the image is widened is lowered compared to that at the position 5A. The oscillation angle correction unit 73 calculates an oscillation angle (swing angle) of the mirror unit 40 such that a difference in illuminance (brightness) of the image projection surface 5 is smaller than a predetermined reference or a selected reference and the illuminance is substantially even in correspondence with the distance information, and sends the oscillation angle to the oscillation angle calculation unit 63. In a case where the information from the oscillation angle correction unit 73 is input to the oscillation angle calculation unit 63, the oscillation angle calculation unit 63 determines the oscillation angle (the swing angle) of the mirror unit 40 in association with the drawing line information from the drawing timing generation unit 61 and the information from the oscillation angle correction unit 73, and sends the oscillation angle to the drive circuit 70. Then, the light deflection unit 7 is driven based on the information. The oscillation angle (the swing angle) of the mirror unit 40 is controlled according to the value of the voltage applied to the mirror driving unit 41 of the light deflection unit 7.

In the embodiment, the torsional shaft 43 relating to the main scanning is twisted at a swing angle of 40 degrees in the main scanning direction when being applied with a voltage of 120 V, and twisted at a swing angle of 30 degrees in the main scanning direction when being applied with a voltage of 90 V. The swing angle of the torsional shaft 43 corresponds to the oscillation angle in the main scanning direction of a mirror 40. The torsional shaft 48 relating to the sub scanning is twisted at a swing angle of 20 degrees in the sub scanning direction when being applied with a voltage of 50 V, and twisted at a swing angle of 17 degrees in the sub scanning direction when being applied with a voltage of 40 V. The swing angle corresponds to the oscillation angle (the swing angle) in the sub scanning direction of the mirror unit 40. In this way, the oscillation angle of the mirror unit 40 can be controlled by the value of the applied voltage. Then, when the oscillation angle of the mirror unit 40 is corrected based on the distance information, a projection area of the projection image 6 is reduced as much as the corrected amount of the oscillation angle compared to the case of no correction. Therefore, it is possible to reduce a difference in illuminance (brightness) in the image projection surface 5.

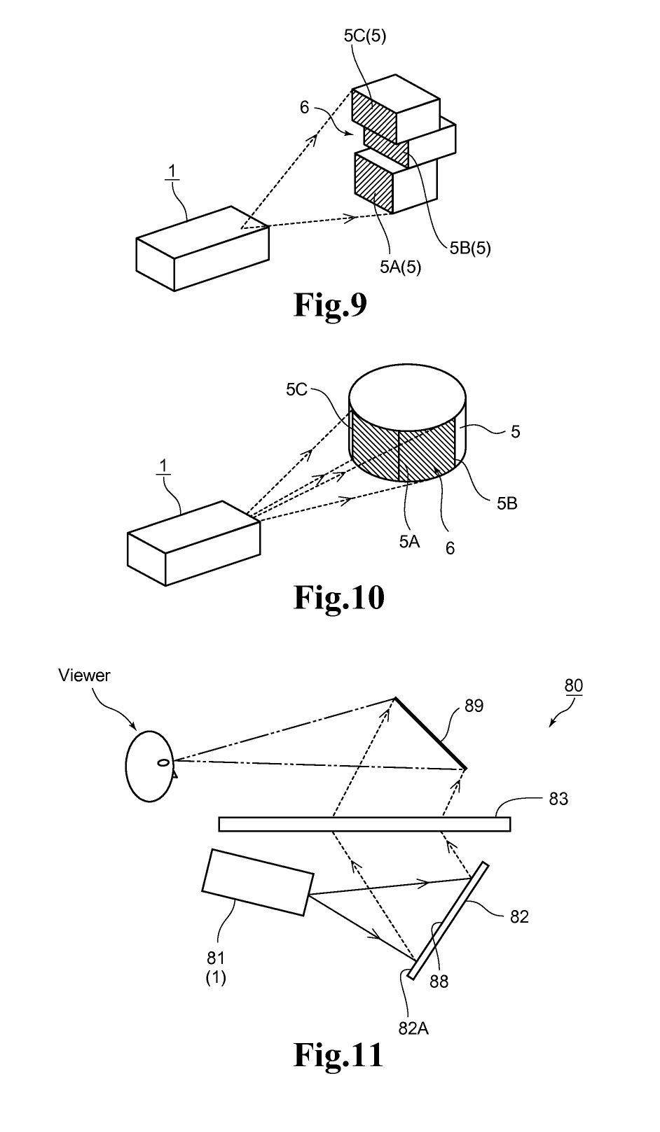

According to the scanning projection apparatus 1 of the above-mentioned embodiment, it is possible to project the projection image having a small difference in illuminance (brightness) even onto the image projection surface having the three-dimensional uneven structure or the image projection surface having the curved surface, which will be described by giving examples illustrated in FIGS. 9 and 10.

FIG. 9 is a diagram illustrating an example of a case where the image projection surface 5 includes a three-dimensional uneven structure. As illustrated in FIG. 9, the image projection surface 5 is configured of three stacked blocks, and the image projection surface 5 facing the scanning projection apparatus 1 includes three projection surfaces 5A, 5B, and 5C from the bottom. In this way, in a case where the image projection surface 5 has steps generally in a height direction with respect to the scanning projection apparatus 1, the oscillation angle (the swing angle) in a vertical direction (the sub scanning direction) of the mirror unit 40 is controlled according to distances (differences in distance to the respective projection surfaces, that is, steps) from the scanning projection apparatus 1 to the respective projection surfaces 5A, 5B, and 5C. In the illustrated example, the surface 5A within the nearest distance from the scanning projection apparatus 1 is set as a projection reference surface, and steps (differences in distance) between the surface 5B and 5A, surface 5C and 5A are detected, so that the oscillation angle of the mirror unit 40 in the sub scanning direction is controlled. In other words, a voltage applied to the mirror driving unit 41 is controlled such that the oscillation angles of the mirror unit 40 for the surfaces 5B and 5C become smaller than that in the surface 5A.

FIG. 10 is a diagram illustrating an example of a case where the image projection surface 5 is a curved surface. As illustrated in FIG. 10, the image projection surface 5 is configured of a side surface of a cylindrical three-dimensional object. In this way, in a case where the image projection surface 5 includes the curved surface, and in a case where the image projection surface 5 has a difference in distance generally in a lateral direction (horizontal direction) with respect to the scanning projection apparatus 1, the oscillation angle in the horizontal direction (the main scanning direction) of the mirror unit 40 is controlled according to distances to the respective positions in the projection surface. For example, the position 5A within the nearest distance from the scanning projection apparatus 1 is set as a projection reference position, and differences in distance between the position 5B and 5A, position 5C and 5A are detected, so that the oscillation angle (the swing angle) of the mirror unit 40 is controlled to make a difference in illuminance (brightness) of the projection image 6 smaller than a predetermined reference or a selected reference. In other words, a voltage to be applied to the mirror driving unit 41 may be controlled to make the projection area of the projection image 6 reduced in the vicinity of the position 5B and in the vicinity of the position 5C. Further, a distance (a difference in distance) is continuously detected in a range covering an area from the right end (the position 5B) to the left end (the position 5C) of the image projection surface 5, and the oscillation angle of the mirror unit 40 may be controlled whenever the distance is detected.

The scanning projection apparatus 1 of the first embodiment described above scans the image projection surface 5 two-dimensionally with the laser beam emitted from the first light source module 2 using the light deflection unit 7 to project the projection image 6 onto the image projection surface 5. Since the laser beams are arranged into the parallel light beam, it is possible to project the projection image 6 clearly regardless of a distance from the scanning projection apparatus 1 to the image projection surface 5.

The projection image 6 emitted from the light deflection unit 7 becomes wider as a distance to the image projection surface 5 is increased, and the illuminance (brightness) at the position where the projection image 6 is widened is lowered. Then, the distance from the mirror unit 40 to the image projection surface 5, or the differences in distance between the respective positions in the image projection surface 5 is detected by the light detection unit 9, and the oscillation angle of the mirror unit 40 is controlled according to the detected distances (the differences in distance). In other words, since the oscillation angle is set to be small in the image projection surface at a position far away to reduce the projection area of the projection image, it is possible to reduce the difference in illuminance (brightness) over the entire image projection surface 5 compared to the case where the oscillation angle is not controlled. However, the light detection unit 9 may not be provided.

Further, the first light source module 2 includes the red laser light source 22, the green laser light source 24, and the blue laser light source 25. For example, in a case where the wavelength of the red laser beam is 640 nm, the wavelength of the green laser beam is 515 nm, and the wavelength of the blue laser beam is 450 nm, since the laser beams of these colors are on a high level of color purity, it is possible to obtain a wide range of color reproducibility with respect to the input image signal.

Further, the first light source module 2 of the embodiment includes a plurality of laser light sources which emit the laser beams having different wavelengths according to the image signal, and synthesizes and emits the laser beams emitted from the plurality of laser light sources using the multiplexing unit 4, so that the projection image having a high illuminance (brightness) can be obtained. Therefore, it is possible to detect the reflection light beam from the image projection surface 5 using the light detection unit 9 to acquire the information on the distance to the image projection surface 5 or the difference in distance with accuracy.

Further, the light deflection unit 7 of the embodiment is configured in the MEMS structure of the electrostatic drive system which includes the mirror unit 40 and the mirror driving unit 41 oscillating the mirror unit 40. Therefore, the oscillation (drive) of the mirror 40 can be realized according to the voltage applied to the mirror driving unit 41 (between the mirror-side comb-like electrode 45 and the first comb-like electrode 46, and between the second comb-like electrode 50 and the outer-frame-side comb-like electrode 51).

Further, the MEMS structure can be accurately manufactured with the utilization of a semiconductor manufacturing technology. With this MEMS structure, a scanning position (the swing angle of the mirror unit 40) of the laser beam can be accurately controlled, and furthermore it is excellent even in responsiveness. Therefore, it is possible to achieve miniaturization, low noise, and low power consumption by employing the MEMS structure of the electrostatic drive system as a light deflection unit 7.

Further, the mirror unit 40 is configured such that the perpendicular two shafts (in the embodiment, two shafts of the torsional shaft 43 and the torsional shaft 48) can be separately oscillated. Therefore, even in a case where the image projection surface 5 has an uneven structure or a curved surface in any of the vertical direction or the horizontal direction, the projection image 6 of which the difference in illuminance (brightness) is small is obtained. Further, as described above, since the oscillation angle of the mirror unit 40 can be controlled by separating two shafts individually, a linear or spotted image on a projection screen can be used as a marker for the projection.

Further, a drive amount between the mirror-side comb-like electrode 45 and the first comb-like electrode 46, and a drive amount between the second comb-like electrode 50 and the outer-frame-side comb-like electrode 51 can be detected by detecting electrostatic capacitance between the mirror-side comb-like electrode 45 and the first comb-like electrode 46, and electrostatic capacitance between the second comb-like electrode 50 and the outer-frame-side comb-like electrode 51. In other words, the swing angle (the oscillation angle) of the mirror unit 40 can be detected. Therefore, based on the swing angle, a control unit 20 controls a voltage applied to the mirror driving unit 41, so that it is possible to control the oscillation (drive) with a high accuracy. Furthermore, the light deflection unit 7 of the embodiment includes the oscillation angle detection unit 52 in the torsional shaft 43, and the oscillation angle detection unit 53 in the torsional shaft 48. With these configurations, the oscillation angle of the mirror unit 40 is detected, so that the oscillation angle (the swing angle) of the mirror unit 40 can be more accurately controlled.

Further, the scanning projection apparatus 1 of the embodiment can be provided with the second light source module 3 (the combining light source module) which is used by combination with the first light source module 2. The laser beam emitted from the first light source module 2 and the laser beam emitted from the second light source module 3 are combined by the multiplexing unit 4. With the use of the multiplexing unit 4, the laser beams emitted from the first light source module 2 and the second light source module 3 can be integrated into one optical flux, and thus the illuminance can be improved.

Further, in the embodiment, the second light source module 3 may incorporate an appropriate laser light source as needed. Therefore, a desired performance or function can be sufficiently exerted according to needs. For example, in a case where brightness is necessary, it is possible to employ a configuration in which two green laser light sources 36 are provided in the second light source module 3 as illustrated in FIG. 4. Further, it is possible to select and incorporate laser light sources which emit the laser beams having appropriate outputs and colors according to outputs or visible sensitivities of the laser light sources.

Further, the scanning projection apparatus 1 of the embodiment may be configured such that the infrared sensor including an infrared laser light source which can emit the infrared laser is attached to the second light source module 3 instead of the red, green, or blue laser light sources. In addition, the infrared sensor further includes the light receiving unit which receives the reflection light beam of the emitted light beam, so that a distance to the image projection surface 5 can be measured by the light receiving unit. Further, the infrared sensor can have a function equivalent to the light detection unit 9. However, other sensors except the infrared sensor may be employed as the light detection units. As an example of such a sensor, various types of sensors can be used such as those employing a photodiode of the light projection/reception system, and those recognizing a movement in image processing. Further, even in such a case where the projection image 6 looks dim, or the contrast of the projection image 6 is large, the distance is effectively measured by using the infrared laser light source.

### Second Embodiment

Subsequently, a scanning projection apparatus according to a second embodiment of the invention will be described with reference the drawings. In the scanning projection apparatus of the second embodiment, an optical imaging element is added to the scanning projection apparatus 1 of the first embodiment to project a projection image (a midair image) in a space.

FIG. 11 is a diagram schematically illustrating a scanning projection apparatus 80 according to the second embodiment. The scanning projection apparatus 80 is an optical apparatus which forms the projection image (the midair image) by emitting a projection image 89 into the midair from an irradiation light projecting apparatus 82. As illustrated in FIG. 11, the scanning projection apparatus 80 includes a light source unit 81, an irradiation light projection unit 82 through which the laser beam emitted from the light source unit 81 is irradiated as the projection image, and an optical imaging unit 83. In addition, the light source unit 81 corresponds to the scanning projection apparatus 1 (see FIG. 1) of the first embodiment, and includes the first light source module 2, the second light source module 3, the light deflection unit 7, and the like. Therefore, the description of the light source unit 81 will not be repeated. Further, the irradiation light projecting apparatus 82 of the embodiment is a screen which includes a reflection surface 82A, that is, a mirror.

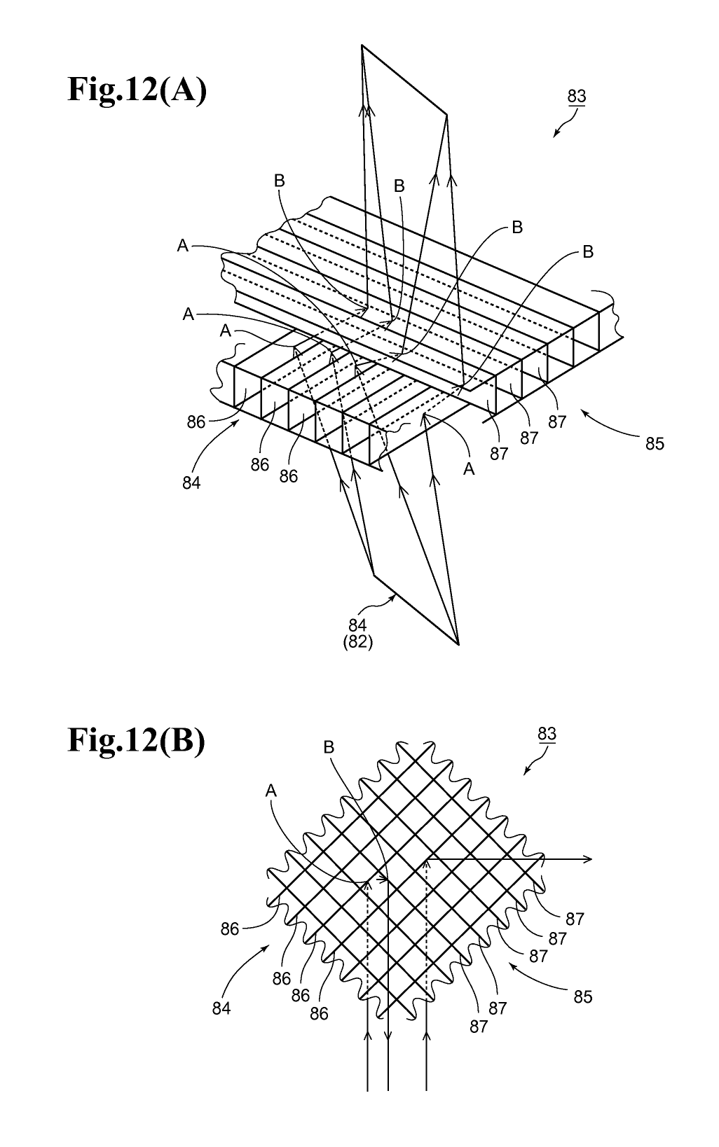

The light source unit 81, the irradiation light projection unit 82, and the optical imaging unit 83 are commonly supported by a housing (not illustrated). The housing includes a light-emitting aperture (not illustrated) in a direction of arrangement of the optical imaging unit 83. In the housing, the light source unit 81, the irradiation light projection unit 82, and the optical imaging unit 83 are separately supported by supporting members. In addition, the irradiation light projection unit 82 and the optical imaging unit 83 may be integrally supported by a common supporting member. The configuration of the optical imaging unit 83 will be described with reference to FIG. 12.

FIG. 12A is a perspective view illustrating an example of the configuration of the optical imaging unit 83 of the embodiment, and FIG. 12B is a plan view partially illustrating the optical imaging unit 83 illustrated in FIG. 12A. In addition, FIG. 12A illustrates a principle of forming an optical image in the optical imaging unit 83. As illustrated in FIG. 12A, the optical imaging unit 83 further includes a first light control panel 84 and a second light control panel 85. The first light control panel 84 is configured such that plan reflection surface portions 86 having metal reflection surfaces vertically provided along a thickness direction of a transparent plate are arranged at a constant pitch. Similarly, the second light control panel 85 is also configured such that plan reflection surface portions 87 having metal reflection surfaces vertically provided along the thickness direction of the transparent plate are arranged at a constant pitch. Then, the first light control panel 84 and the second light control panel 85 are disposed such that the reflection surface portions 86 and the reflection surface portions 87 are perpendicular to each other, and the surfaces facing to each other come in close contact and are fixed with a transparent adhesive or the like.

For example, the first light control panel 84 and the second light control panel 85 are each formed such that a number of transparent resin plates (for example, acryl resin plates) or glass plates, each of which includes a metal reflection surface having a deposit layer made of aluminum or silver on one surface side, are stacked to be disposed on one side.

When the light beams emitted from the irradiation light projection unit 82 on one surface side (the surface opposite to the second light control panel 85) of the first light control panel 84 of the optical imaging unit 83 are obliquely incident on the lower surface of the first light control panel 84, the incident light beams enter the first light control panel 84 and are reflected at points A of the reflection surface portions 86. Then, the reflection light beams reflected on the reflection surface portions 86 enter the second light control panel 85 from surfaces having no plan reflection plates of the second light control panel 85. Some of the light beams entering the second light control panel 85 are reflected at points B of the reflection surface portions 87, travel in the first light control panel 84, and then are released to the outside from surfaces having no the reflection surface portions 87 of the second light control panel 85.

Herein, as illustrated in FIG. 12B, the reflection surface portions 86 and the reflection surface portions 87 are disposed in a direction perpendicular to each other, and are disposed to face each other to reflect the reflection light beams on the reflection surface portions 86 again. Therefore, when the light beams incident on the reflection surface portions 86 and reflected at points A among the light beams traveling in the first light control panel 84 are reflected at points B of the reflection surface portions 87 a second time, the second reflection light beams become parallel to the light beams incident on the reflection surface portions 86 in plan view. Therefore, the projection image 88 projected onto the irradiation light projection unit 82 is converged onto a position symmetrical to a projection image 88 with the optical imaging unit 83 interposed therebetween, and can be recognized as the projection image (the midair image) 89 by a viewer. In a case where the light beams incident on the reflection surface portions 86 and reflected at points A are not reflected on the reflection surface portions 87 a second time, the light beams are released to the outside. In addition, the projection image 89 is an image formed by reversing the projection image 88 projected onto the irradiation light projection unit 82.

In addition, it is desirable that the irradiation light projection unit 82 of the embodiment be disposed at an angle to emit the reflection light beam in a direction different from the emitting direction of the laser beam emitted from the light source unit 81. Further, it is desirable that the optical imaging unit 83 be disposed to form a predetermined angle with respect to the reflection surface (the projection surface) 82A of the irradiation light projection unit 82.

According to the scanning projection apparatus 80 of the second embodiment described above, since the laser beam emitted from the light source unit 81 is the parallel light beam, it is possible to keep a predetermined diameter of the light beam regardless of a distance to an image projection position (the irradiation light projection unit 82 in the embodiment). Therefore, it is possible to form a clear projection image. Then, since the optical imaging unit 83 having an optical transparency in a direction emitting the reflection light beam from the irradiation light projection unit 82 is disposed, it is possible to project the projection image (the midair image) 89 in a space on a side opposite to the irradiation light projection unit 82 to be symmetric to the projection image 88 projected onto the irradiation light projection unit 82 with the optical imaging unit 83 interposed therebetween. In addition, as illustrated in FIG. 11, the irradiation light projection unit 82 is obliquely disposed with respect to the emitting direction of the laser beam emitted from the light source unit 81. In other words, the reflection surface 82A of the irradiation light projection unit 82 (the image projection surface with respect to the light source unit 81) is disposed such that the distance from the light source unit 81 is increased compared to that on the lower side as it goes to the optical imaging unit 83. In the light source unit 81, since the oscillation angle of the mirror unit 40 can be controlled according to the difference in distance, the projection image 88 projected onto the irradiation light projection unit 82 can be formed as a clear projection image having a small difference in illuminance (brightness) on the reflection surface 82A. Therefore, the projection image (the midair image) 89 can also be projected clearly. In addition, the light source unit 81 may be configured not to include an optical detection unit 9.

In the embodiment, the viewer can recognize the projection image (the midair image) 89 in sight on the surface of the optical imaging unit 83. At this time, the viewer can look at the projection image (the midair image) 89 at a predetermined angle with respect to the optical imaging unit 83. The angle of the projection image (the midair image) 89 is determined by an angle of the irradiation light projection unit 82 with respect to the light source unit 81, and an angle of the optical imaging unit 83 with respect to the irradiation light projection unit 82. Then, when the angle of the irradiation light projection unit 82 with respect to the light source unit 81 and the angle of the optical imaging unit 83 with respect to the irradiation light projection unit 82 are adjusted to be an angle equal to a visual line direction of the viewer, the viewer can always recognize a good projection image (the midair image) 89. In addition, the change of these angles can be performed by changing attachment angles of the supporting members which support the irradiation light projection unit 82 and the optical imaging unit 83. For example, these angles can be changed by motors for driving the supporting members or by using operation members which are provided outside the housing for the connection with the supporting members. At this time, it is also possible to adjust the angle with respect to the light source unit 81 by providing a common supporting member which serves to support the irradiation light projection unit 82 and the optical imaging unit 83 and to integrally operate the irradiation light projection unit 82 and the optical imaging unit 83.

Further, the angle of the projection image (the midair image) 89 can be adjusted with respect to the visual line even by changing an irradiation angle of the laser beam emitted from the light source unit 81 onto the irradiation light projection unit 82. For example, an image forming position of the projection image (the midair image) 89 can be moved by inclining a scanning range of the mirror unit 40 toward any one of the main scanning direction (the horizontal direction) or the sub scanning direction (the vertical direction).

### Third Embodiment

Subsequently, a portable projection apparatus 90 which uses the scanning projection apparatus 1 will be described with reference to the drawing. The portable projection apparatus 90 can be applied to eyeglasses type, a helmet type, a headphone type, or a compact projection apparatus which is freely portable. Herein, the headphone type will be described as an example. Therefore, the portable projection apparatus 90 will be described as a headphone 90.

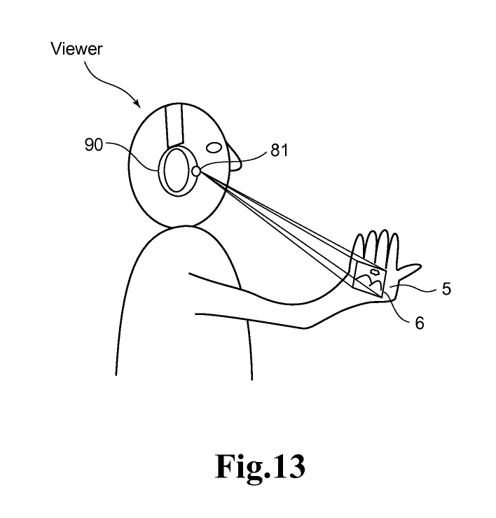

FIG. 13 is a schematic view illustrating a use state of the headphone 90 as a portable projection apparatus according to the embodiment. As illustrated in FIG. 13, the headphone 90 is configured to have the light source unit 81 built therein, and can emit the laser beam in the visual line direction of the viewer. The light source unit 81 of the embodiment corresponds to the scanning projection apparatus 1 described in the first embodiment, emits the projection image in the visual line direction of the viewer according to an input image signal, and projects the projection image 6 onto a palm which is the image projection surface 5. The image signal is input to the light source unit 81 by a wireless communication unit from an image output body part (not illustrated). The light source unit 81 includes the light detection unit 9 (see FIG. 1) provided in the scanning projection apparatus 1. The light source unit 81 detects distances from the light source unit 81 to the respective positions in the image projection surface 5, and can change the oscillation angle of the mirror unit 40 such that a difference in illuminance (brightness) of the projection image 6 becomes small in a range of the image projection surface 5. In addition, the light detection unit 9 may not be provided.

As described above, in a case where a distance to the image projection surface 5 is increased, the portable projection apparatus 90 of the embodiment makes the oscillation angle of the mirror unit 40 small to reduce the projection area of the projection image 6, so that it is possible to make substantially even illuminance while reducing the difference in illuminance (brightness) according to a position in the projection image 6. Further, even in a case where the position, distance, or inclination of the image projection surface 5 is not constant with respect to the laser beam such as the palm as illustrated in FIG. 13, the light source unit 81 can project the projection image using a laser beam flux which is almost the parallel light beam. Therefore, it is possible to form a good projection image 6 regardless of the distance. Further, a good projection image 6 can be formed on the image projection surface 5 (for example, the palm) even at any position in the image projection surface 5.

Further, in the embodiment, the description has been made about a case where the image projection surface 5 is the palm. However, the image projection surface 5 can form a good projection image 6 even in a wall, a floor, a desk, and so on as long as it is a relatively short distance away and the oscillation angle of the mirror unit 40 is changed according to the distance.

In addition, FIG. 13 illustrates the portable projection apparatus 90 of the headphone type, and the light source unit 81 may be assembled to eyeglasses or goggles. For example, except that the projection image 6 of the image projection surface 5 such as the palm is formed as illustrated in FIG. 13, the case of the eyeglasses or the goggles can also be applied to an apparatus in which the laser beam emitted from the light source unit 81 is reflected on the mirror and the reflection light beam is recognized, that is, a head mount display type of projection apparatus. In a case where the light source unit 81 of the embodiment is used, since the scanned laser beam becomes substantially the parallel light beam, a good projection image can be formed even when a distance from the light source unit 81 to the image projection surface 5, for example, is several cm to several tens of cm.

Hitherto, the scanning projection apparatuses 1 and 80 and the portable projection apparatus 90 have been described in the respective embodiments of the invention, and various modifications can be made without departing from the scope of the invention. For example, in the first embodiment described above, the optical components included in the first light source module 2, the second light source module 3, and the optical unit 39 are not limited to those described above, but various other components may be additionally or selectively used if necessary. As such an optical component, a mirror such as a half mirror or a dichroic mirror, various types of lenses, various types of prisms, and optical filters are exemplified.

Further, in the first embodiment described above, the second light source module 3 corresponds to the combining light source module, but the number of combining light source modules is not limited to “1”, and a plurality of combining light source modules may be employed. In this case, the arrangement of the laser light sources may be equal or may be different in the plurality of combining light source modules. Further, a plurality of first light source modules 2 may be employed.

In the respective embodiments described above, the light deflection unit 7 has been described about the MEMS structure of the electrostatic drive system in which the mirror unit 40 and the mirror driving unit 41 oscillating the mirror unit 40 are included. However, the light deflection unit 7 is not limited to the electrostatic drive system of the MEMS type. As another light deflection unit, there is a metal-based optical scanning element employing a metal base structure of a piezoelectric drive type, and a piezoelectric system using a distortion of the piezoelectric element may be employed. Further, an electromagnetic system to drive the mirror unit by a magnetic force may be employed.

Further, in the first embodiment, the distance in the image projection surface 5 (the difference in distance) is detected by the light detection unit 9 and the oscillation angle (the swing angle) of the mirror unit 40 is adjusted. However, a method of detecting other than the distance may be employed. For example, it is also possible to employ a method in which a reference image included among the input image signals is projected onto the image projection surface including the uneven structure or the curved surface to capture an image by an image capture unit such as a CCD camera or a CMOS camera, a difference between the reference image and the projection image is detected, and the oscillation angle (the swing angle) of the mirror unit 40 is determined using image body timing information which is corrected based on the difference information in advance. Further, a light detection apparatus such as the light detection unit 9 may not be provided.

Further, the oscillation angle of the mirror unit 40 may be adjusted every one scanning cycle of the laser beam, or may be adjusted such that an oscillation angle at an initial stage of the image projection is determined and then the projection is continuously performed in a range of the oscillation angle as long as there is no change in the image projection surface 5.

Further, the description has been made about that the first light source module 2 includes the plurality of laser light sources having different wavelengths. However, the first light source module 2 may be configured by a light source module which includes one laser light source emitting the light beams having one or plural wavelengths. Further, in the respective embodiments described above, the image signal is input, but a simple signal may be used.

The scanning projection apparatuses 1 and 80 and the portable projection apparatus 90 of the respective embodiments described above are applicable to a curved multi-screen and a deformed display (for example, a lengthened display, a free-shaped display, a circular display, a hollow display, or the like) while being strengthened in the respective advantages. Furthermore, the apparatuses can also be applied to an advertisement hung in the ceiling which changes its display according to a viewing direction, a space touch switch (for example, a switch to be reluctantly touched such as a flush switch of a toilet), a medical display of an operation room, or a monitor display for a workplace.

1. A scanning projection apparatus comprising:
a light source module which includes a laser light source to emit a laser beam;
a light deflection unit which includes an oscillating mirror unit and performs a two-dimensional scanning with the laser beam emitted from the light source module by the mirror unit to project a projection image onto an image projection surface;
a light detection unit which detects a distance from the mirror unit to the image projection surface or a difference in distance in the image projection surface; and
a control unit which controls an oscillation angle of the mirror unit based on distance information from the light detection unit.

2. The scanning projection apparatus according to claim 1, wherein
the light source module includes any one or all of a red laser light source, a green laser light source, and a blue laser light source.

3. The scanning projection apparatus according to claim 1, wherein
the laser light source includes a plurality of laser light sources which emit laser beams different in wavelength according to an image signal,
the scanning projection apparatus further comprising:
a multiplexing unit which synthesizes the laser beams emitted from the plurality of laser light sources.

4. The scanning projection apparatus according to claim 1, wherein
the light deflection unit has a MEMS structure of an electrostatic drive system in which the mirror unit and a mirror driving unit to oscillate the mirror unit are included.

5. The scanning projection apparatus according to claim 1, wherein
the mirror unit is separately oscillated by two shafts perpendicular to each other, and
oscillation angles of the two shafts are separately controlled based on the distance information by the control unit.

6. The scanning projection apparatus according to claim 1, wherein
the light deflection unit includes an oscillation angle detection unit which detects the oscillation angle of the mirror unit.

7. The scanning projection apparatus according to claim 1, further comprising:
a combining light source module which emits the laser beam and is combined with the light source module,
wherein the laser beam emitted from the light source module and the laser beam emitted from the combining light source module are synthesized by the multiplexing unit.

8. A scanning projection apparatus comprising:
a light source module which includes a laser light source to emit a laser beam;
a light deflection unit which includes an oscillating mirror unit and performs a two-dimensional scanning with the laser beam emitted from the light source module by the mirror unit to project a projection image onto an image projection surface;
an irradiation light projection unit which reflects the laser beam emitted from the light deflection unit in a direction different from an emitting direction; and
a transparent optical imaging unit which is disposed at a predetermined angle with respect to a projection surface of the irradiation light projection unit in the emitting direction of a reflection light beam from the irradiation light projection unit, and
the projection image is projected into a space on a side opposite to the irradiation light projection unit with the optical imaging unit interposed therebetween.

9. The scanning projection apparatus according to claim 8, wherein
an angle of the optical imaging unit with respect to the irradiation light projection unit is changed according to a position on a visual line of a viewer.

10. A portable projection apparatus which uses the scanning projection apparatus according to claim 1.

11. A portable projection apparatus which uses the scanning projection apparatus according to claim 8.
